(19) United States
(12) Patent Application Publication
(10) Pub. No.: US 2014/0316926 A1
(43) Pub. Date: Oct. 23, 2014

(54) Automated Market Maker in Monitoring Services Marketplace

(71) Applicant: CONCURIX CORPORATION, Kirkland, WA (US)

(72) Inventors: Alexander G. Gounares, Kirkland, WA (US); Russell S. Krajec, Loveland, CO (US)

(21) Appl. No.: 13/867,063

(22) Filed: Apr. 20, 2013

(51) Int. Cl. G06Q 30/06

(52) U.S. Cl. CPC G06Q 30/0611
USPC 705/26.4

(57) ABSTRACT

An application services marketplace may match various solution providers to a solution request, then creating a bid or proposal for services. Upon acceptance of the bid, the services may be configured and deployed. A market maker may combine multiple solution providers to address a specific request, and may use a schema expressly defined or implied in a request to select and configure a combination of services. The market maker may combine monitoring services with analysis services, monitoring services with load generators, or other combination of services that may be used during development or deployment of an application.

### BACKGROUND

Computer application monitoring may be used during development of an application, as well as during production use of the application. During development, an application may be monitored during testing and debugging to help the developer understand the application and inform the developer of any problem areas. During production use of the application, monitoring systems may gather performance metrics and other data to alert an administrator of any problems as well as to track the general health of the application and the hardware on which the application may execute.

### SUMMARY

A marketplace for monitoring services providers may configure and deploy monitoring and other services that meet a solution definition for a given application. The services may include monitoring and tracing, analysis, rendering, debugging, optimizing, load generating, and other solution providers. The solution definition may include a schema or other data definitions for parameters gathered during application execution, as well as definitions for parameters or solutions that may be desired. The marketplace may identify those services that may be configured to meet the solution definition, then configure and deploy the selected services. A financial clearinghouse may handle financial payments to the various service providers.

A load generator services marketplace may configure and deploy load generators in conjunction with executing an application. The load generators may be selected based on a solution definition, which may include the types of loads and conditions under which loads may be generated. One or more load generators may be configured to operate with a monitoring service, and a connection manager may cause the load generators, application, and monitoring service to execute simultaneously so that the monitoring service may capture performance metrics while the application experiences the load. The marketplace may have load generators from multiple providers and with multiple configurations, as well as a clearinghouse for clearing a financial transaction as the load generators are used.

An application development environment may have a user interface to a marketplace for development related services, such as monitoring, debugging, load generating, analysis, and other services. Service providers may make their products available through the marketplace, and in some cases, the providers may bid for placement in the user interface. The services may be paid or free, and a clearinghouse may handle financial transactions that may occur. The application development environment may include an editor, debugger, compiler, and other tools by which a developer may write, edit, test, and debug an application. The marketplace may detect characteristics about the application under development, and make those characteristics available to various service providers.

An application services marketplace may match various solution providers to a solution request, then creating a bid or proposal for services. Upon acceptance of the bid, the services may be configured and deployed. A market maker may combine multiple solution providers to address a specific request, and may use a schema expressly defined or implied in a request to select and configure a combination of services. The market maker may combine monitoring services with analysis services, monitoring services with load generators, or other combination of services that may be used during development or deployment of an application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a solution marketplace.

FIG. 2 is a diagram illustration of an embodiment showing a network environment that contains a marketplace for solutions relating to creating, testing, debugging, and executing applications.

FIG. 3 is a diagram illustration of an embodiment showing a service provider system.

FIG. 4 is a diagram illustration of an example embodiment showing interactions between a customer workstation and a marketplace.

FIG. 5 is a diagram illustration of an embodiment showing an example customer interface.

FIG. 6 is a diagram illustration of an embodiment showing a second example customer interface.

FIG. 7 is a flowchart illustration of an embodiment showing a method performed by a customer device.

FIG. 8 is a flowchart illustration of an embodiment showing a method for using a service marketplace to find solutions to errors.

FIG. 9 is a flowchart illustration of an embodiment showing interactions between various components in a marketplace environment.

FIG. 10 is a flowchart illustration of an embodiment showing a method for processing requests by a market maker.

### DETAILED DESCRIPTION

### Marketplace for Monitoring Services

A marketplace may configure and deploy services for developing or administering a computer application. The marketplace may accept services from multiple vendors, where each service may have various schema that defines input and output data that a service may process. In response to a solution definition, one or more services may be configured and deployed.

The services may be any type of service that may assist a developer in creating, debugging, testing, and deploying an application, as well as services that an administrator may use while an application is in production use. Examples of the services may include monitoring and tracing, analysis, optimization, debugging, load generators, library and code providers, and other solution providers. In some cases, two or more services may be configured to operate in parallel or in a serial pipeline configuration.

The marketplace may configure data to flow between various services to create a requested solution. For example, a monitoring service may trace an application within a runtime environment and generate a set of monitored parameters. An analysis service may accept the monitored parameters to generate some type of output parameters, which may in turn be displayed by a rendering service. The analysis service may provide time series analysis, for example, which may be rendered in near-real time by the rendering service.

In such an example, a schema may be defined for the output, as well as the monitored parameters and the output parameters generated by the analysis service. The schemas may be expressly defined or inferred from a requested solution, and the various services may be configured according to the schemas in some cases.

The marketplace may also clear transactions. In some embodiments, the service providers may require financial payment for access to the services. As a service may be used by an end user, the end user's account may be debited and the service provider's account may be credited.

The marketplace may enable service providers to bid on providing services to an end user. In response to a solution request, a solution provider may create a bid that may include a cost for accessing the service. When two or more solution providers may create bids, the solution provider with the lowest bid may be accepted by the end user.

In some cases, the marketplace may include a user interface in which multiple service providers may have advertisements or otherwise display their services. In such cases, the service providers may bid on having their advertisement displayed, and the service providers with the highest bid may enjoy having their advertisement displayed in the user interface.

Load Generator Marketplace

A marketplace may include load generator services that may be configured and deployed to meet a solution definition. Load generators may create a load against a monitored application to cause the application to operate under various conditions.

During testing and debugging, a load generator may exercise an application so that a developer may identify bottlenecks or performance problems with the application. In some such uses, a load generator may attempt to increase load on an application until the application experiences problems.

In some cases, an application may have performance goals, and application acceptance may be completed only when the application's performance meets or exceeds a goal. In such cases, the load generator may generate a predefined load that an application may be expected to handle.

Load generators may be used in concurrency testing, software performance testing, reliability testing, volume testing, stress testing, and other types of exercises. As such, each load generator may have different characteristics that may be more suitable for specific tasks. Further, two or more vendors may each have solutions for specific types of loads, and the marketplace may serve as a forum where a buyer may compare and select an appropriate load tester for a given task.

A user may create a solution definition that may define the types of loads and a schema or other definition for the details of the loads requested. In some cases, a load generator may be configured to interact with a monitoring agent that may gather performance metrics when an application may be subjected to the load.

A marketplace manager may attempt to automatically match an appropriate load generator with a given solution definition. In some cases, an automatic connection manager may configure, launch, and manager the load generator during execution. In some cases, a human operator may interact with the load generator to manually configure and manually control the operation of the load generator.

Load generators may be used for load testing, which may allow a developer to monitor an application under load. A developer may look for bottlenecks or other conditions that may inhibit performance. Stress testing may exercise an application under extreme load to determine the boundaries of a performance map. Endurance testing or soak testing may exercise an application over a long period of time, which may reveal memory leaks, process leaks, or other bugs that may arise over time. Spike testing may test a system by increasing load suddenly to test a system's ability to respond to changes in loads.

Compliance testing or standards testing may use load generators that produce standardized loads that may be used to certify compliance with predefined standards. Such testing may be used to compare two different applications using standardized metrics.

Application Development Environment with Marketplace Interface

An application development environment may have an interface to a services marketplace. The application development environment may have an editor, compiler, debugging tools, and other components by which a programmer or developer may create and test an application. The services marketplace may include a user interface where a user may select and interact with service providers.

The development environment may create a set of descriptors for an application and make those descriptors available in the marketplace. The descriptors may describe certain characteristics of the application and the service providers may prepare proposals for services that may be provided for the application. The proposals may be shown to the user, who may select one or more proposals to implement.

The descriptors may include metadata about the application being developed. Such descriptors may include the programming language, libraries used by the application and other metadata that may be used as a filter to select some services.

A programming language descriptor may help filter services that may be language specific. For example, some monitoring services may plug into source code, intermediate code, or other language-specific interfaces, and those services that may not support a given language may be filtered from a user interface.

Descriptors that include libraries or other services accessed by an application may give a hint about the type of application, as well as identify service providers that may have solutions that relate to or focus on specific libraries or other services.

In some cases, the descriptors may include performance related data, which may include any type of data that may be gathered when an application executes. In a simple example, summarized performance data may identify an application as being constrained by memory, network access, or processor capabilities. In a more complex example, performance data may include statistics or other descriptors that define how the application responds to specific loads.

Proposals may be generated by the service providers or by some other party. The proposals may take into account information in the set of descriptors and may be relevant to the application being developed. In some cases, a proposal may be customized for the specific application under development. For example, a set of descriptors that may define a server in a web-based client/server architecture using a specific protocol, and a service provider that has an applicable product may create a proposal that may be shown to the developer. The proposal may be an advertisement for services, and may include estimated performance gains or other sales information that may be tailored to the developer's application.

In some cases, the proposals may be generated by the service providers themselves. In such cases, each service provider may identify solutions that may be applicable and provide those solutions in a proposal. In other cases, proposals may be generated by another party, which may be automated components of the services marketplace or by third party market makers that may generate proposals using one or more services in a single proposal.

The service providers may bid for inclusion in the marketplace user interface. For example, a service provider may generate a proposal and bid a certain amount of money for the privilege of displaying a proposal in the user interface. In some cases, the proposals may be shown to a user using relevance scores or other metrics to sort the proposals. One of the metrics for sorting or grouping the proposals may be the bids for display rights.

The proposals may also include bids or financial terms for executing the services associated with the proposals. Such bids may be the cost that an end user may pay for engaging the offered services.

Market Maker for Computer Services Marketplace

A market maker in a computer services marketplace may automatically identify and configure a service provider to meet a solution request. The solution request may include a schema, which may in turn define data fields or parameters that may be output, and in some cases parameters that may be used as input to the services.

In some cases, the market maker may combine multiple services to provide a single solution. The single solution may link two or more services together in a pipeline or parallel configuration by matching input and output schemas of various solutions, and configuring the solutions to operate with the various schemas.

The market maker may generate proposals or bids for solutions, and the bids may include pricing or division of proceeds for the solution providers. In some cases the bidding process may involve multiple solution providers bidding to provide a service defined by the market maker. The services market may have a clearinghouse that may collect payment from various payers and pay the payees when a transaction has been completed.

The market maker may use schemas to match services to a solution request. Each solution provider may have a schema that may define the data types that the solution provider receives as well as emits. The market maker may match solution providers together to deliver a requested solution, and may configure the various services to meet a requested solution.

The market mater may match services by defining intermediate schemas that may join two or more different solution providers. For example, a solution request may define an incoming schema comprising the parameters to be collected and an outgoing schema comprising desired output parameters. A market maker may attempt to find one service that can generate the parameters to be collected and a second service that may generate the desired output parameters. The market maker may also define an intermediate schema that may define how the first service may connect to the second service. Once the services can be configured to the schemas, the solution may be fully defined.

Throughout this specification and claims, the terms “profiler”, “tracer”, and “instrumentation” are used interchangeably. These terms refer to any mechanism that may collect data when an application is executed. In a classic definition, “instrumentation” may refer to stubs, hooks, or other data collection mechanisms that may be inserted into executable code and thereby change the executable code, whereas “profiler” or “tracer” may classically refer to data collection mechanisms that may not change the executable code. The use of any of these terms and their derivatives may implicate or imply the other. For example, data collection using a “tracer” may be performed using non-contact data collection in the classic sense of a “tracer” as well as data collection using the classic definition of “instrumentation” where the executable code may be changed. Similarly, data collected through “instrumentation” may include data collection using non-contact data collection mechanisms.

Further, data collected through “profiling”, “tracing”, and “instrumentation” may include any type of data that may be collected, including performance related data such as processing times, throughput, performance counters, and the like. The collected data may include function names, parameters passed, memory object names and contents, messages passed, message contents, registry settings, register contents, error flags, interrupts, or any other parameter or other collectable data regarding an application being traced.

Throughout this specification and claims, the term “execution environment” may be used to refer to any type of supporting software used to execute an application. An example of an execution environment is an operating system. In some illustrations, an “execution environment” may be shown separately from an operating system. This may be to illustrate a virtual machine, such as a process virtual machine, that provides various support functions for an application. In other embodiments, a virtual machine may be a system virtual machine that may include its own internal operating system and may simulate an entire computer system. Throughout this specification and claims, the term “execution environment” includes operating systems and other systems that may or may not have readily identifiable “virtual machines” or other supporting software.

Throughout this specification, like reference numbers signify the same elements throughout the description of the figures.

In the specification and claims, references to “a processor” includes multiple processors. In some cases, a process that may be performed by “a processor” may be actually performed by multiple processors on the same device or on different devices. For the purposes of this specification and claims, any reference to “a processor” shall include multiple processors which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

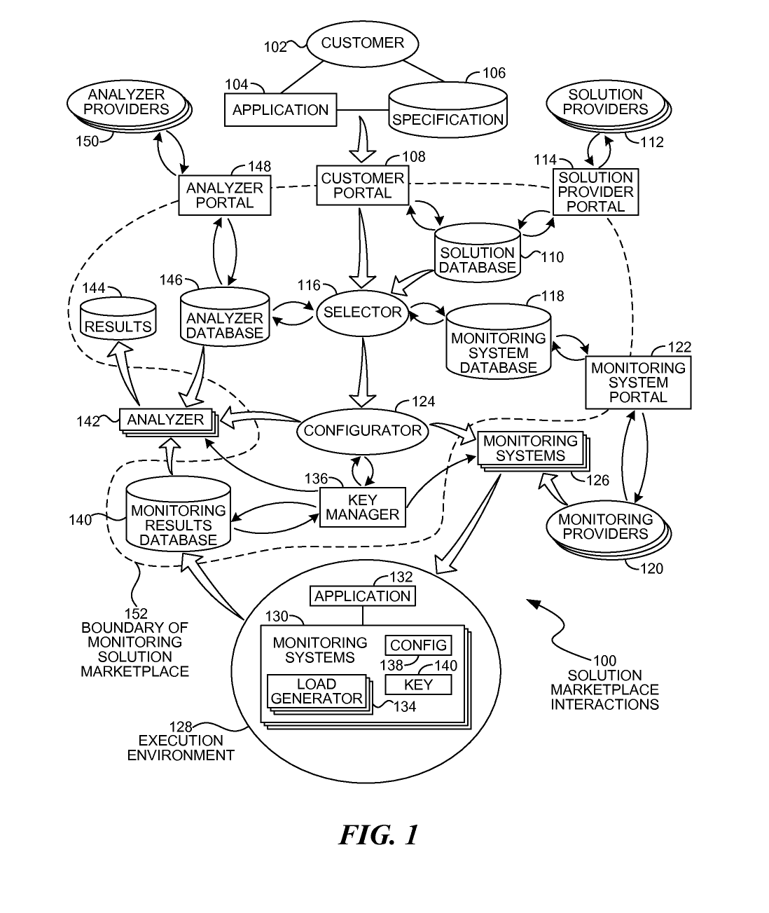

FIG. 1 is a diagram of an embodiment 100 showing a solution marketplace with interactions between the various components. Embodiment 100 is merely one example of how a marketplace may function with different types of computer service providers, and how those service providers may be configured to operate with an application under test.

Embodiment 100 illustrates high level interactions between various components in a marketplace. In the example of embodiment 100, a customer 102 may interact with various solution providers 112, monitoring providers 120, and analyzer providers 150 to monitor and analyze an application 104.

The solution providers 112 may act as market makers and may combine multiple monitoring and analysis components into a single solution. The monitoring and analysis components may be provided by different companies and may have varying capabilities. In some cases, the marketplace may function by having a customer 102 interact with the monitoring providers 120 and analyzer providers 150 through the marketplace without using a solution provider 112.

The solution marketplace may have a customer portal 108 through which a user may engage the services of the various providers. In a typical use scenario, a customer may establish an account and enter various information, such as a payment mechanism. Through the customer portal 108, a customer 102 may be able to enter information about the application 104 in the form of a specification 106. The specification may be a solution definition comprising parameters to gather, desired output, and other information.

The customer portal 108 may have a user interface through which a user may browse different service providers. In some cases, the service providers may provide solicitations or advertisements for services in the customer portal 108.

In one use scenario, a customer 102 may provide some details about the application 104. The details may include metadata about the application 104 as well as some performance related data that may have been gathered during previous tests. These details may be part of the specification 106 that the various service providers may analyze to determine whether or not the services may be applicable. In some cases, the service providers may analyze the specification 106 and generate custom tailored proposals for the customer.

In some embodiments, the various service providers may bid for the opportunity to be shown in the customer portal. The bids may be financial offers for placement in the user interface, and the successful bids may be shown to the user in a prominent place on the user interface. The bidding system may be a blind bidding system where each service provider bids a price without knowing any other bidder's prices. Other bidding systems may be open where each bidder may be able to see the highest bidder.

Such a bidding system may be useful for service providers to gain market share by spending money to have their services at least viewed and possibly purchased by a customer. In cases where a particular service provider may have a service offering that addresses a customer's specification very completely, the service provider may bid a high amount. In cases where the same service provider may have an offering but that offering may not be as closely matched as in the previous case, the service provider may bid a lower amount.

When a service provider is presented in the customer portal 108, the customer 102 may be able to learn about the service provider and make a decision to use the service provider or not. When the service provider is selected by a customer, the service provider may be automatically configured and, in some cases, launched to begin providing the requested service.

The customer portal 108 may be any type of user interface. In some cases, the customer portal 108 may be a web page or other interface. In other cases, the customer portal 108 may be part of a development environment, as will be described later in this specification.

A solution database 110 may contain various solutions that may use multiple service providers. The solution providers 112 may be solution providers that may create solutions for various niche conditions, or market makers who may create solutions that use capabilities from multiple providers. In some cases, these solutions may be defined by macros, executable code, or other definitions as well as connection information to various service providers.

In some cases, a customer 102 may not select a specific service provider, but may instead define the services that are desired. In such a case, the service providers may bid against each other for the opportunity to provide the service.

For example, a customer 102 may request that an application be monitored using a load generator. The customer may define the parameters to measure during monitoring, but not specify the monitoring service. In such an example, the marketplace may have a facility for either selecting the lowest bidding service provider that meets the monitoring criteria, or may send a specification to each service provider and receive bids for providing the service. In such an example, the marketplace may determine the actual service provider for a particular customer situation and the customer may or may not be aware of the actual provider. In some cases, the customer may be able to select between different providers, or specify groups of providers to use or avoid.

A selector 116 may attempt to match the customer's specification 106 with a monitor by analyzing a monitoring system database 118. The selector 116 may compare schemas and other metadata from the specification 106 with similar information supplied by the monitoring providers 120.

A monitoring provider 120 may have a monitoring system portal 122 as an interface into the marketplace. A monitoring provider 120 may create an account, describe the available monitoring services, and specify other information that may be stored in the monitoring system database 118. The monitoring provider may establish a financial account that may be used for paying for bids or for receiving payments for services rendered.

In many embodiments, the monitoring system portal 122 may be a user interface through which the monitoring service provider may view the number of services provided, types of services provided, and various statistics about the services rendered, as well as view specifications and statistics for opportunities that were missed.

The monitoring system portal 122 may enable a monitoring service provider 120 to establish bids and bidding algorithms for having proposals displayed in the customer portal 108 as well as bids and bidding algorithms for providing services that may be selected by the selector 116.

A configurator 124 may configure a monitoring system 126 based on the output of the selector 116. The monitoring system 126 may be connected to an execution environment 128 in which the application 132 may be executed. During execution, the monitoring system 130 may operate with a load generator 134.

In the example of embodiment 100, the load generator 134 is illustrated as being part of a monitoring system 130. In other embodiments, a load generator may be provided by a different service provider that may specialize in load generators.

The monitoring system 130 may operate with a configuration 138 that may define data collected by the monitoring system 130. The configuration 138 may define what data to collect and the conditions under which collection may occur. In many cases, the configuration 138 may be defined by the configurator 124 in response to the specification 106 provided by a customer 102.

In some embodiments, a key manager 136 may create various access keys, such as the key 140, that may be used to track usage of various systems. The key 140 may be used by a clearinghouse to log the amount of time a service was used, the user associated with the services, and any other information from which payment for the services may be distributed. The key manager 136 may provide keys for any service provided within the marketplace.

The application 132 may be executed with multiple monitoring systems in some cases. Such situations may occur when one monitoring system may not have all the capabilities that may be requested. As such, the selector 116 may identify two or more monitoring systems that may monitor an application 132. In some cases, each monitoring system may operate in a different execution environment, although some cases may have two or more monitoring systems configured to operate in a single execution environment.

The execution environment 128 may be any type of hardware and software system in which an application 132 may be executed. In some cases, the execution environment 128 may be a production hardware and software configuration that may have a monitoring system applied. In other cases, the execution environment 128 may be a system that may have specialized hardware and software components that may gather data while the application 128 executes.

The output of the monitoring systems 130 may be stored in a monitoring results database 140. The data stored in the monitoring results database 140 may be consumed by one or more analyzers 142, which may be yet another service provider in the marketplace 152.

The analyzers 142 may provide various analyses of the monitored data. Some analyzers may visualize the data, while other analyzers may provide optimizations or other performance analyses. Still other analyzers may identify bottlenecks or chokepoints in an application, while still more analyzers may provide other optimizations, analysis, or other services. Any of the analyzers may output results 144 that may be consumed by the customer 102.

The analyzers 142 may come from various analyzer providers 150, who may interface with the marketplace 152 through an analyzer portal 148. Like the solution provider portal 114 or the monitoring system portal 122, the analyzer portal 148 may be a user interface or programmatic interface through which an analyzer provider 150 may make their services available to the marketplace and otherwise interact with the marketplace 152.

In some embodiments, a marketplace may have a single service provider portal, where any service provider may register their service for use in the marketplace. In such a portal, the service provider may have an opportunity to classify their service as a monitoring service, aggregation/market maker service, analyzer service, or any other type of service. Some such embodiments may have different metadata or characteristics that may be collected for specific types of services.

The available analyzers may be stored in an analyzer database 146, which may be accessed by a selector 116 when identifying an appropriate analyzer or group of analyzers that may meet a desired solution specification. A configurator 124 may configure the analyzer to operate with the data provided by the monitoring system 130.

In many cases, an analyzer 142 may have a schema that defines the data that the analyzer 142 may accept and the data that the analyzer may emit. The selector 116 may use the schemas to select and configure analyzers for a specific application.

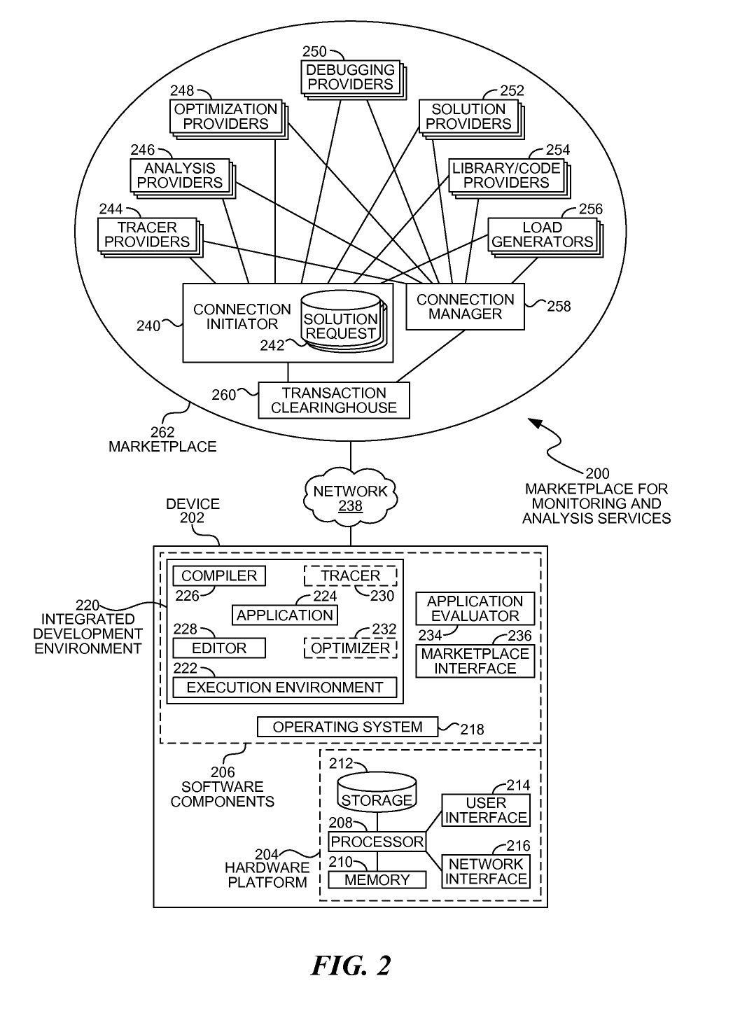

FIG. 2 is a diagram of an embodiment 200 showing a network environment in which a marketplace for computer services may exist. Embodiment 200 illustrates hardware components that may implement some elements of the process of embodiment 100.

Embodiment 200 may illustrate a device 202 that contains an integrated development environment which may access a marketplace of many different services. The integrated development environment may be a workstation on which a developer may write, edit, compile, test, debug, and run an application.

The marketplace may have many different service providers, each having a service that may be defined at least in part using a schema. The schema may define the data that the service may accept and emit, and the schema may be used by a solution provider, market maker, or other marketplace component to identify and join one or more services.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate. An operating system may provide an abstraction layer between executing routines and the hardware components 204, and may include various routines and functions that communicate directly with various hardware components.

An integrated development environment 220 may be one example of a user's interface into a services marketplace. An integrated development environment 220 may include an execution environment 222 in which an application 224 may be executed. An editor 228 and compiler 226 may be used to, respectively, create the application and compile the application for execution.

In some embodiments, services accessed through a marketplace may be executed on the device 202 and, in some cases, within the integrated development environment 220. For example, a tracer 230 and optimizer 232 may be modules or other components that may be obtained through the marketplace 262 and executed within the integrated development environment 220. In some cases, services obtained through the marketplace 262 may be executed on other hardware platforms, which may include hardware platforms managed by the service provider.

The device 202 may include an application evaluator 234 and marketplace interface 236. The application evaluator 234 may analyze operations within the integrated development environment 220 to detect metadata describing the application 224, and the metadata may be made part of a solution request for the marketplace 262.

The marketplace interface 236 may be a programmatic or user interface to the marketplace 262. In a programmatic interface, a solution definition and other information may be passed to and from the marketplace 262. In a user interface, a user may have a command line, graphical user interface, or other interface with which the user may interact with the marketplace 262.

The application evaluator 234 and marketplace interface 236 may operate with little or no user interaction in some cases. For example, the application evaluator 234 may detect the computer programming language being used, libraries being referenced, and in some cases, some initial performance metrics about an application 224. Such information may be contained in a solution request that may be transmitted to the marketplace 262, and various service providers may create proposals or other offers for services that may be useful to the programmer. Such offers may be made available within the integrated development environment 220 for a user to browse and select.

A solution request 242 may be expressly requested by a user. Such a request may be formulated using the marketplace interface 236 and other tools to specify the types of services requested and the conditions under which the services may execute. In such a case, the user may take an active role in specifying various parameters regarding the solution request 242.

In other embodiments, a solution request 242 may be implied or suggested by the application evaluator 234 without the user's involvement. In such a case, the user may not be aware that a solution request 242 may have been generated.

A network 238 may connect the device 202 with the marketplace 262.

The marketplace 262 may be illustrated as a single entity in embodiment 200. In many cases, the marketplace 262 may be implemented as a group of devices that may interact to perform the operations of the marketplace and the services provided through the marketplace.

A connection initiator 240 may receive solution requests 242 that may define services that may be requested or at least conditions under which services may be provided.

In some cases, the connection initiator 240 may make the solution requests 242 available and service providers may create proposals that may meet some or all of the definitions in a solution request 242. In such embodiments, the connection initiator 240 may transmit the proposals to the marketplace interface 236, and may receive a selection of one of the proposals. The connection initiator 240 may then pass the process of configuring the services to the connection manager 258, which may control the actual execution of the selected service.

In some cases, the connection initiator 240 may select one or more services as possible solutions to a given solution request 242. In such an embodiment, the connection initiator 240 may search the various service providers that match the metadata, schema, and other definitions contained within a solution request 242.

The connection initiator 240 may be capable of joining multiple services together to provide a single service for a user. For example, a tracing service may be joined to an analysis service, which may in turn be joined to an optimization service. The net effect to a user may be a single optimization service, but portions of the overall service may be provided by different products from different companies or providers.

Examples of solution providers may include tracer providers 244, analysis providers 246, optimization providers 248, debugging providers 250, generalized solution providers 252, library or code providers 254, load generators 256, and other providers.

A tracer provider 244 may have services that gather information during the execution of an application. In some cases, tracer services may focus on performance metrics and may be lightweight enough so as not to adversely affect the performance of an application. In other cases, tracer services may be quite detailed, and while such services may adversely affect performance, such tracer services may gather very detailed information about the sequence of execution and the code being executed.

Analysis providers 246 may have services that may analyze tracer output. Analysis services may evaluate log files, stack traces, or other output to develop performance metrics, display real time or historical data, summarize tracer data, identify bottlenecks or other performance issues, or any other type of analysis.

Optimization providers 248 may provide optimization services that may suggest changes to the application, settings during execution, or other changes that may optimize for various parameters.

Debugging provider 250 may have services that may assist in debugging an application. Such services may have specialized analyses, algorithms, or other techniques for identifying problems in an application so that a developer may fix them. In some case, the debugging services may assist in explaining or pinpointing problems that may arise when error codes are encountered or for problems that may arise during compiling or execution.

Solution providers 252 may provide general services or solutions not defined by other providers that may be listed. Some solution providers may be market makers that may evaluate a solution request 242 and join two or more services together to meet some or all of a solution request 242.

Library or code providers 254 may provide various services regarding application code. For example, a library service may analyze function calls being made by an application to determine if a similar library function may be available. Typically, a library function may be tested, debugged, and supported in a more rigorous manner than a function within a user's application and therefore may be more desirable.

Load generators 256 may provide simulated loads that may be run against an application. A load generator service may create inputs for an application so that a tracer service, for example, may gather performance data while the application executes. Load generators may be tailored to specific types of loads, such as user interface loads, web service calls, or other types of loads, and many load generators may be configurable to generate loads in many different manners.

The connection manager 258 may establish connections between a service provider and an application being executed. One architecture may be to download a service to the device 202 and execute the service locally. In another architecture, some or all of the service may be provided on a remote hardware platform, such as a remote server or cloud computing platform.

The connection manager 258 may establish a connection between a service provider and a customer system, then facilitate the use of the service. In some cases, a user input to control the service may be passed through the connection manager 258 and be passed to the service provider. In other cases, the connection manager 258 may establish a peer to peer relationship between a customer and a service provider such that commands may be passed between the customer and service provider without going through the connection manager 258.

A transaction clearinghouse 260 may manage financial payments that may be a result of a service being used. The clearinghouse 260 may detect that a service has been established, detect the billing and financial parameters for using the service, and detect when the service has been used. The clearinghouse 260 may facilitate payments between a customer and a service provider on an ongoing basis while the service is being provided, or before or after the service has been provided.

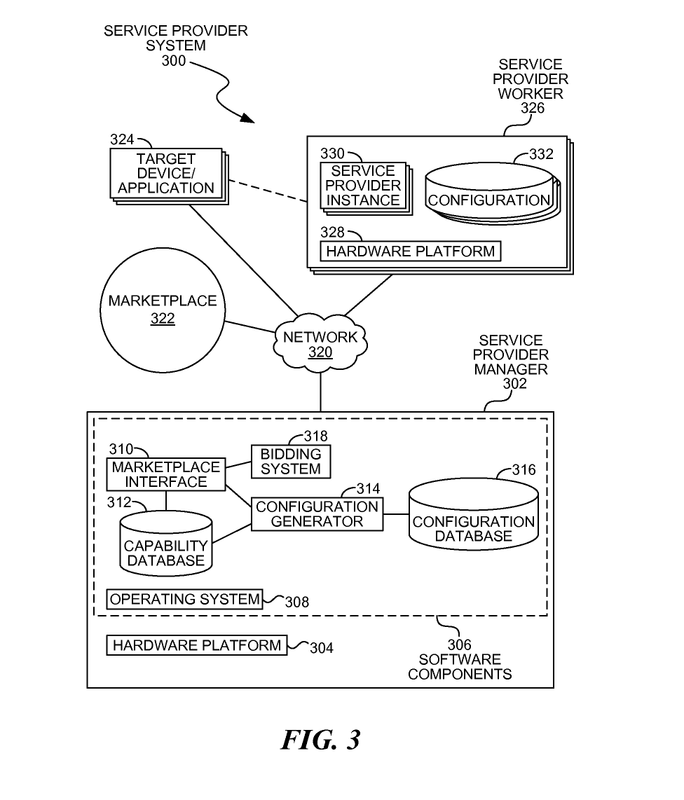

FIG. 3 is a diagram of an embodiment 300 showing a network environment in which a service provider may engage a customer's application or device. Embodiment 300 illustrates an example of a service provider manager 302 that may manage a group of service provider clients 326 which may deliver a requested service.

Embodiment 300 may illustrate the architecture of a service provider that may interact with a marketplace 322 and may be configured to deliver services. A service provider manager 302 may be a device that interacts with the marketplace 322 by preparing proposals and submitting bids, then may configure various client devices to actually provide the service.

The diagram of FIG. 3 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

The architecture of embodiment 300 may illustrate one device that may provide administrative and management functions for a service provider, and several client devices that may deliver the actual services. Such an architecture may be scalable as large number of client devices may deliver services and may be managed by a small number of manager devices.

A service provider manager 302 may have a hardware platform 304, which may be similar to the hardware platform 204 described in embodiment 200. In some cases, the hardware platform 304 may be a cloud based hardware fabric.

In the example of embodiment 300, the service provider manager 302 may be illustrated as fully automated software components that provide various functions. In many embodiments, an administrator may have a user interface to adjust, monitor, configure, and otherwise interact with the software components illustrated.

The software components 306 may include an operating system 308 on which various software components may execute. The software components may include a marketplace interface 310 that may communicate with the marketplace 322 to receive solution requests, transmit proposals, as well as other functions.

The marketplace 322 may have a solution request that may come from a customer or end user. The solution request may be an express solution request where the customer identifies specific services and a configuration for the services requested. In some cases, the solution request may comprise metadata about an application, performance data, or other information that may be gleaned from an integrated development environment or other mechanism. In such cases, the solution request may or may not be expressly identified by an end user as something that may be desired.

For solution requests where a customer may have expressly indicated that some or all of the conditions may be desired, the marketplace and associated service providers may attempt to create proposals that meet each of the various services and conditions. In some such cases, the service providers may indicate specific conditions or services that may not be met. In some cases, the service providers may propose solutions that deviate from a customer's expressly defined criteria.

Solution requests where a customer may not have expressly defined conditions may be more of an open ended solution request. For example, a solution request may merely identify metadata regarding an application, such as the language of the source code and a set of libraries that are called. From such information, a service provider may have more latitude to suggest services that may be applicable to a given situation. In such cases, an end user may not even be aware that some services exist, yet such services may be displayed in a manner that the user may browse the services to learn more about them. Such cases may provide a mechanism for service providers to advertise their services and solicit new customers.

A capability database 312 may contain the range of services that a specific service provider may have available. The capability database 312 may contain schemas and other metadata regarding the services, and such schemas and metadata may be compared to various solution requests to develop proposals.

A bidding system 318 may create bids for submissions to the marketplace 322. Bids may be made in several instances. In one instance, a bid may be placed for advertisements that may be displayed in a customer user interface for the marketplace. Such a bid may be a price that the service provider may be willing to pay for placement on the customer user interface. In some cases, such a bid may be for a single view of the service provider's advertisement, while in other cases, a bid may be for clicks or selection of the service provider's advertisement.

In another instance, a bid may be made for a proposal that may match a solution request. Such a bid may be a price that a customer may pay for using the services.

A configuration generator 314 may create specific configuration settings for each engagement with a customer. The configuration database 316 may store such configurations for recall by a service provider worker 326. The configuration settings may define a connection mechanism between a service provider client and a customer's application or device, in some cases. The configuration settings may also define schemas or other definitions of data to collect, analyses to perform, output to generate, or other configurable functions for a given service.

A network 320 may connect the service provider manager 302 with the marketplace 322, a target device or application 324, and various service provider workers 326.

The target device or application 324 may be a device under test, application under test, or other recipient of the services provided by the system. The device or application under test may be located in any type of execution environment, including testing environments, production environments, or other environments.

A service provider worker 326 may be a device that has a hardware platform 328 and a service provider instance 330. The service provider instances 330 may have configurations 332 that define the operations of the service provider instances 330 with respect to the specific target device or application 324.

The service provider instances 330 may be the computer application that provides the actual service against the target device. In many cases, multiple service provider instances may be created and configured for various devices under test. In some cases, two or more service provider instances 330 may be configured to operate against a single device under test, while in other instances, one service provider instance 330 may be able to provide services to multiple devices under test.

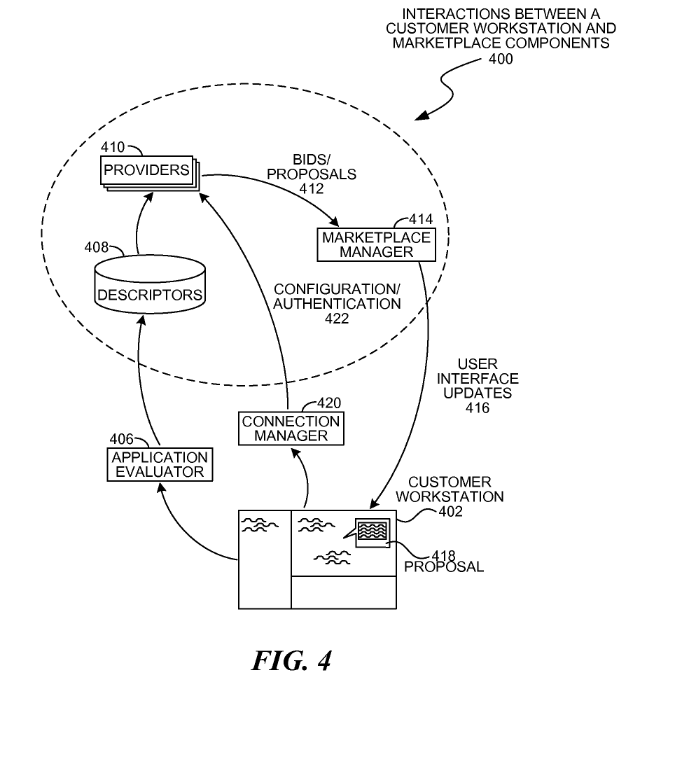

FIG. 4 is a diagram of an embodiment 400 showing interactions between a user interface and marketplace components. Embodiment 400 may illustrate a series of interactions between a customer system as illustrated by a customer workstation 402 and a marketplace 404.

Embodiment 400 may illustrate merely one simplified sequence of interactions between a customer and a services marketplace. Other sequences and interactions may be possible with various embodiments of a marketplace.

A customer may interact with a customer workstation 402, which may be an integrated development environment. A typical integrated development environment may have an editor, compiler, and other facilities so that a developer may create, execute, debug, test, and otherwise interact with an application. In some cases, a developer may use separate software components to accomplish a similar result. For example, a developer may use a command line interface from which an editor may be launched, and from which an application may be compiled, executed, and debugged.

From the customer workstation 402, an application evaluator 406 may generate a set of descriptors 408 for the marketplace 404. The descriptors 408 may serve as an implied solution request, and may include metadata and sometimes performance data about an application being developed on the customer workstation 402. Such metadata may include a computer language being used, libraries referenced, external services accessed, and other descriptors of the developer's application. In some cases, the descriptors 408 may include performance related data, such as debugging information or error reports from compilation or execution, performance metrics that may be generated while executing the application under load, or other information.

The descriptors 408 may be evaluated by multiple providers 410. Each provider 410 may have a different service, and may evaluate how well their service may match the descriptors 408. The providers 410 may generate bids or proposals 412, which may be sent to a marketplace manager 414.

The bids or proposals 412 may be advertisements for a particular service. In some cases, the advertisements may be customized for the particular application being developed. For example, an advertisement may be tailored for the computer language, libraries referenced, or other elements that may be present in the descriptors 408. Such advertisements may also include connection information that may enable a direct peer-to-peer connection between a customer application and a service, should the customer select a service.

The marketplace manager 414 may manage information being passed back from the marketplace 404 to the customer workstation 402. When many providers 410 submit proposals 412, the marketplace manager may transmit the proposals that have the highest bids. In this case, a service provider may provide a bid that is a financial amount that the service provider is willing to pay to have their service displayed on the customer's system. In such systems, the marketplace manager 414 may sort and filter the proposals to identify those services with the winning bids, then display those proposals.

In some cases, the marketplace manager 414 may attempt to identify the proposals that most closely match the descriptors 408. In such cases, the marketplace manager 414 may score each proposal based on how well the proposal matched the descriptors 408. In some embodiments, such a score may reflect popularity of a given service provider, feedback received from previous customers, or other factors as well.

The marketplace manager 414 may send a set of user interface updates 416 to the customer workstation 402. The user interface updates may contain the selected and sorted proposals or advertisements, which may be a subset of all the proposals received by the marketplace manager 414.

The user interface updates 416 may be displayed on the customer workstation 402 as proposal 418. When a customer selects the proposal 418, the selection may be received by a connection manager 420, which may send a configuration and authorization 422 to the selected service provider 410. The configuration and authorization 422 may set up a communication session between the application and the service provider, as well as configure the service provider for the specific conditions of the application.

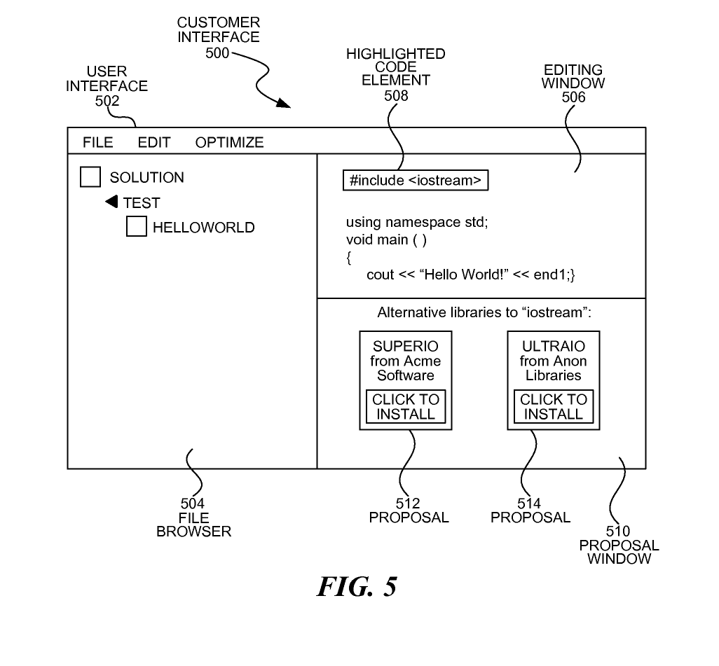

FIG. 5 is a diagram illustration of an example embodiment 500 showing a customer interface with a code editor. The user interface 502 may be a portion of an integrated development environment or merely for a code editor that may have a connection to a services marketplace.

Embodiment 500 may illustrate a use for the services marketplace to suggest code elements by extracting code elements from an application and searching for replacement code elements. In the example of embodiment 500, a library call in a program may be identified as having several replacement options, which may be displayed as proposals in the user interface.

A user interface 502 may contain a file browser 504 and an editing window 506. The file browser 504 may be one mechanism by which a user may select various files to display and edit in the editing window 506. The editing window 506 may display source code and allow a user to add or change the source code.

A highlighted code segment 508 is identified in the editing window 506. In this case, the highlighted code segment 508 may be a library call. The library reference may have been passed to a services marketplace and two proposals may have been received. An example of such a process may have been described in embodiment 400.

A proposal window 510 may include two proposals 512 and 514. In the example of embodiment 500, the proposals may each be advertisements or solicitations for libraries that may replace the library referenced in the highlighted code element 508. Each of the proposals may be configured to install a replacement library if selected by the customer.

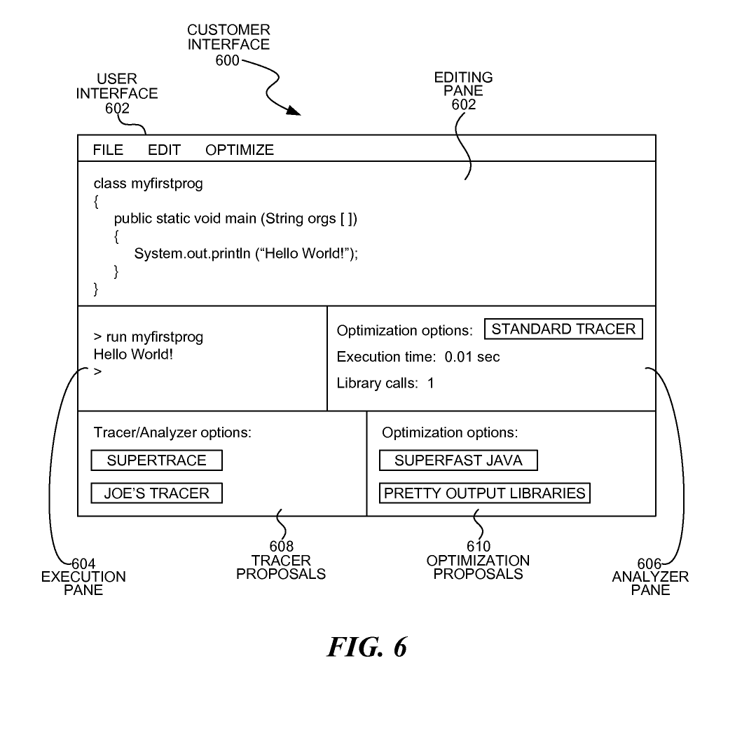

FIG. 6 is a diagram illustration of an example embodiment 600 showing a customer interface with a code editor. The user interface 602 may be a portion of an integrated development environment.

Embodiment 600 may illustrate a use for the services marketplace to suggest services that may be applicable to an application being developed. In the example of embodiment 600, descriptors from code under development may be passed to a marketplace, and certain categories of services may be advertisements may be presented to a user as proposals.

A user interface 602 may contain an editing pane 602, as well as an execution pane 604 and an analyzer pane 606. A developer may edit the code in the editing pane 602, interact with the code using a command line interface in the execution pane 604, and view analysis results in the analyzer pane 606.

The customer workstation may generate descriptors of the user's code and pass those descriptors to a marketplace. The marketplace may identify services that may be applicable to the user's current situation. In some cases, the marketplace may have a manager or other function that may select appropriate services. In some cases, the service providers may analyze descriptors and bid for inclusion of their advertisements in the user interface 602.

In the example of embodiment 600, a set of tracer proposals 608 and a set of optimization proposals 610 may be shown to the user. The tracer proposals 608 may include two different tracer options that may provide different functionality than may be available with the tracer results shown in the analyzer pane 606.

Similarly, the set of optimization proposals 610 may suggest services that may optimize the user's code, provide advanced visualizations, or any other type of analysis and optimization services.

The user may select one or more of the various advertised services, and the selected services may be added to the integrated development environment and used for subsequent analysis of the application under development.

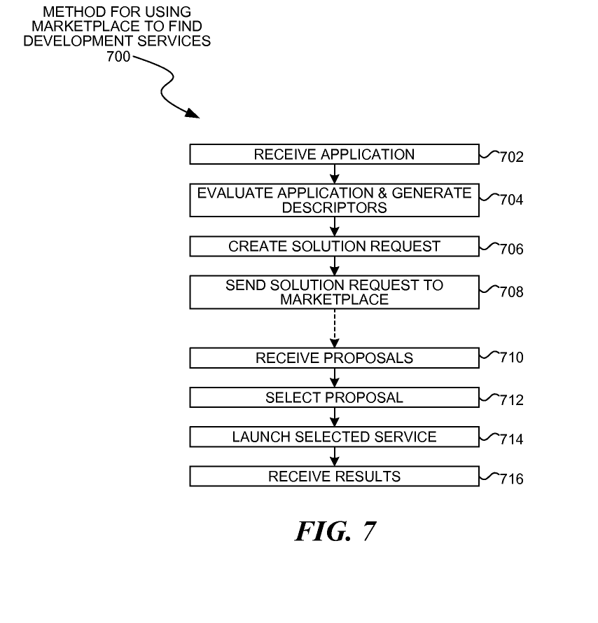

FIG. 7 is a flowchart illustration of an embodiment 700 showing a method for using a marketplace to find development and other services. Embodiment 700 may illustrate a simplified method that may be performed by a customer device, an integrated development environment, or other customer facing interface to the marketplace.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 702, an application may be received. The application may be identified through an editor in an integrated development environment or some other mechanism, such as being identified by a developer in a user interface to the marketplace.

The application may be evaluated in block 704 to generate descriptors of the application. The descriptors may be any type of metadata, code elements, performance data, or other information that a service provider may use to access the relevance of a particular service, to develop a customized solution for the situation, or other analysis.

The descriptors may be added to a solution request in block 706, which may be sent to the marketplace in block 708. In some embodiments, much or all of the operations of blocks 702 through 706 may be performed automatically without any involvement by an end user or customer. In other embodiments, the end user may have varying levels of involvement in selecting the various descriptors or defining the types of services or other criteria for a solution request.

After some period of time, the user's system may receive proposals in block 710, which may be displayed. A proposal may be selected in block 712 and the selected service may be launched in block 714. The results of the service may be received in block 716.

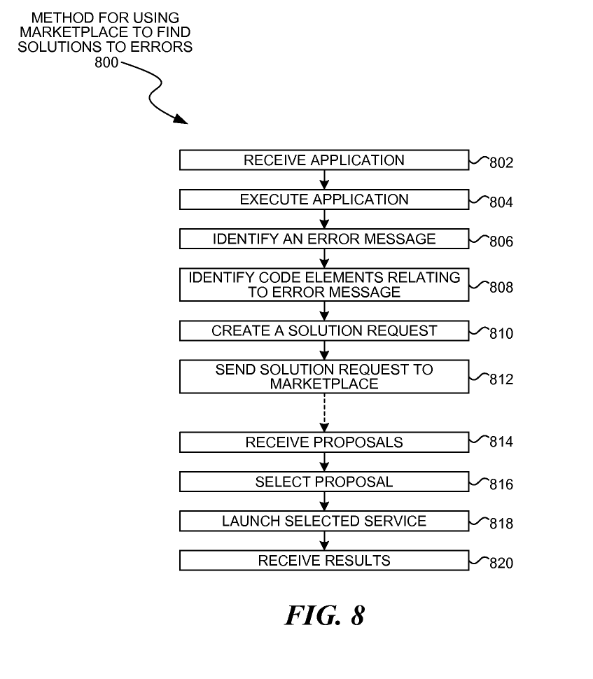

FIG. 8 is a flowchart illustration of an embodiment 800 showing a method for using a marketplace to find assistance with errors that may be encountered when compiling or editing an application. Embodiment 800 may illustrate a simplified method that may be performed by a customer device, an integrated development environment, or other customer facing interface to the marketplace.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

An application may be received in block 802 and attempted to be executed or compiled in block 804.

An error message may be received in block 806. Code elements relating to the error message may be identified in block 808. A solution request may be created in block 810 that may include the error messages, code elements relating to the error message, and other metadata, performance data, or other information. The solution request may be transmitted in block 812 to the marketplace.

The marketplace may return proposals in block 814, which may be displayed to a user. The user may select a proposal in block 816, which may launch the selected service in block 818, the results of which may be received in block 820.

In such an embodiment, the service may provide various types of assistance with the identified error. In one type of service, a library or function may be presented that may replace the identified code elements, for example.

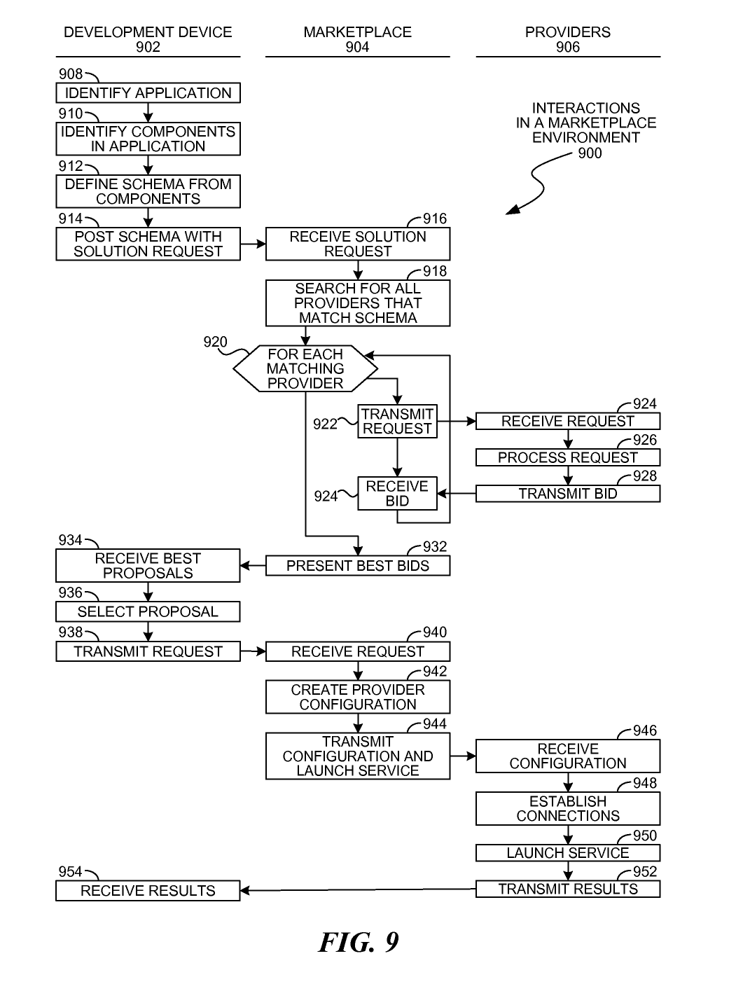

FIG. 9 is a flowchart illustration of an embodiment 900 showing interactions of various components in a marketplace environment. In the left hand column, the operations of a development device 902 may be illustrated. In the center column, the operations of a marketplace 904 are show, while operations of a service provider 906 may be shown in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 900 illustrates an example of a marketplace that matches providers to a schema that may be expressly found or derived from a solution request. In the example of embodiment 900, the marketplace may provide a first level of screening to identify service providers that may match a given schema, then solicit bids from the service providers for a service that may address the solution request.

In block 908, a development device 902 may identify an application and identify components of the application in block 910. The components may be various libraries, services called by the application, or other architectural and design components that may describe the application. Based on the various components, a schema may be defined in block 912 that may identify data elements that may be passed within the application, consumed by the application, or emitted by the application.

The schema may be part of a solution request that may be posted in block 914 to the marketplace 904.

The marketplace 904 may receive the solution request in block 916. Using the schema as a filter or search tool, the marketplace 904 may search for all providers that may have a service that may match at least part of the schema in block 918.

For each matching provider in block 920, the marketplace 904 may transmit a request in block 922 to the selected provider 906.

The selected provider 906 may receive a request in block 924 and process the request in block 926 to generate a response and a bid, which may be transmitted in block 928 to the marketplace 904. The service provider's bid may include a description of the type of service that may be provided, as well as configuration settings or other information that may be used to set up the service provider to interact with the user's application.

The marketplace 904 may receive the bids in block 930, then present the best bids in block 932. The marketplace 904 may filter the bids to select only a subset of the bids to display on the development device 902. In some cases, the service providers may provide advertisement bids that may reflect the amount of money the service provider may pay the marketplace for displaying the proposal.

The development device 902 may receive the bids in block 934 and display the bids for a user to browse and explore. A proposal may be selected in block 936, and the request for the proposal may be transmitted in block 938.

The marketplace 904 may receive the request in block 940. Based on the proposal, the marketplace 904 may create a provider configuration in block 942 and transmit the configuration in block 944 to launch the service. The provider configuration may be any configuration settings that may be used to establish communications, payment systems, and other administrative settings between the service provider 906 and the development device 902. In many cases, the configuration may also include settings, options, and other configuration related parameters that may configure the service provider to engage the application under test in the desired manner. Such configuration may define, for example, which variables to analyze or the type of output desired.

The provider 906 may receive the configuration in block 946, establish connections with the application under test in block 948, and launch the service in block 950. The results of the service may be gathered and transmitted in block 952 and received by the development device 902 in block 954.

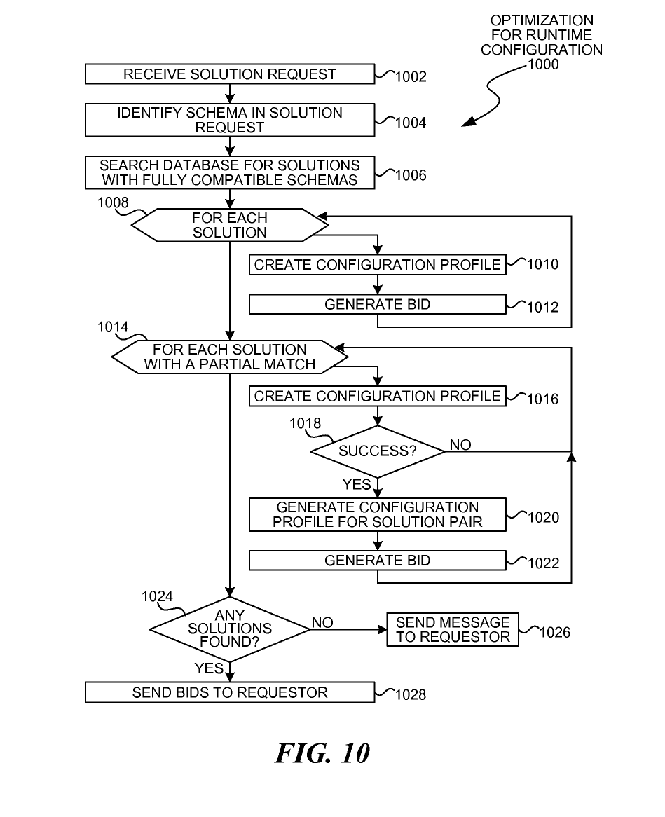

FIG. 10 is a flowchart illustration of an embodiment 1000 showing a method that may be used by a market maker for matching a given schema with one or more services to deliver a solution defined, at least in part, by a schema. Embodiment 1000 may be an example of a market maker service that may be provided as an integral part of a marketplace, or as a service in addition to a marketplace.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 1000 illustrates one method for finding services that match a schema. The schema may define incoming data elements that may be gathered or emitted from an application, as well as output data elements that may be requested in a solution request.

A solution request may be received in block 1002, and a schema may be defined in the solution request in block 1004.

A search may be made in a database of solution providers in block 1006 to identify solution providers with matching or compatible schemas.

Each matching solution provider may be processed in block 1008 to generate a configuration profile for the solution in block 1010 and to generate a bid in block 1012. The configuration profile in block 1010 may define how the service provider may be configured to meet the solution request, as well as any type of communications configuration or other parameters that may be useful. The bid in block 1012 may be a bid for payment that an end user may pay to access the service.

For each solution with a partial match of the schema in block 1014, a search may be made in block 1016 to find a second solution that may match any remaining elements of the schema. If no success is found in block 1018, the process may loop back to block 1014. If success is found in block 1018, a configuration profile for the pair of service providers may be made in block 1020 and a corresponding bid may be generated in block 1022.

In one use scenario, a first service provider may be able to match only a portion of an incoming data schema. A second service provider may be found that may handle the remaining elements of an incoming data schema. In such a situation, two service providers may operate in parallel, where one service provider handles a subset of the incoming data while the other service provider handles the remaining data.

In another use scenario, a first service provider may accept the incoming data schema but not the outgoing data schema. In such a scenario, the output of the first service may be matched with the input of a second service that may generate the output schema defined in the solution request. In such a situation, the two service providers may be configured in a pipeline or serial configuration where the first service provider may generate output that may be consumed by a second service provider, which may generate a desired output.

After performing the analysis of the service providers, as long as one solution may be found in block 1024, the bids may be transmitted to the requestor in block 1028, otherwise a message may be sent to the requestor in block 1026 indicating that no matches were identified for the solution request.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed by a computer processor, said method comprising:
receiving a solution request comprising a schema defining parameters relating to an application;
determining that a first solution provider matches a first parameter defined in said schema;
creating a bid for processing said first parameter according to said solution request;
creating a configuration definition that defines a connection between said application and said first solution provider;
transmitting said bid;
receiving acceptance for said bid and causing said first solution provider to operate according to said configuration definition.

2. The method of claim 1 further comprising:
determining that a second solution provider matches a second parameter defined in said schema; and
said bid further comprising processing said second parameter according to said solution request.

3. The method of claim 2, said first parameter being a parameter gathered during monitoring of said application, said second parameter being an output parameter created from analyzing said first parameter.

4. The method of claim 2, said first solution provider comprising a load generator, said second solution provider comprising an analysis provider.

5. The method of claim 2, said first solution provider comprising a monitoring service, said second solution provider comprising an analysis service.

6. The method of claim 5, said analysis service providing visualizations of data gathered by said monitoring service.

7. The method of claim 1, said parameters defining analysis results from monitoring said application.

8. The method of claim 7, said first solution provider providing monitoring of said application.

9. The method of claim 8, said first solution provider providing analysis of monitored parameters.

10. The method of claim 1, said parameters defining traced parameters gathered while monitoring said application.

11. The method of claim 1, said connection definition comprising a first connection between said application and an intermediary, and a second connection between said first solution provider and said intermediary.

12. The method of claim 1 further comprising:
said bid comprising a financial cost for accessing said first solution provider;
determining that said solution request has met a payment milestone and causing a financial transaction with said first solution provider to be cleared.

13. The method of claim 12, said financial cost being a payment made to said first solution provider.

14. The method of claim 12, said financial cost being a payment made by said first solution provider.

15. A system comprising:
a processor;
a marketplace interface operating on said processor, said marketplace interface that:
receives a solution request, said solution request comprising a schema defining parameters relating to an application;
determines that a first solution provider matches a first parameter defined in said schema;
creates a bid for processing said first parameter according to said solution request;
creates a configuration definition that defines a connection between said application and said first solution provider;
transmits said bid;
receives acceptance for said bid and causes said first solution provider to operate according to said configuration definition.

16. The system of claim 15, said marketplace interface that further:
determines that a second solution provider matches a second parameter defined in said schema; and
said bid further comprising processing said second parameter according to said solution request.

17. The system of claim 16, said first parameter being a parameter gathered during monitoring of said application, said second parameter being an output parameter created from analyzing said first parameter.

18. The system of claim 16, said first solution provider comprising a load generator, said second solution provider comprising an analysis provider.

19. The system of claim 16, said first solution provider comprising a monitoring service, said second solution provider comprising an analysis service.

20. The system of claim 19, said analysis service providing visualizations of data gathered by said monitoring service.
